(19) United States
(12) Patent Application Publication
(10) Pub. No.: US 2026/0252936 A1
(43) Pub. Date: Aug. 27, 2026

(54) Solving a Quantum Computer Problem and Quantum Computer with a Configurable Quantum Circuit

(71) Applicant: Siemens Aktiengesellschaft, München (DE)

(72) Inventors: Oliver von Sicard, München (DE); Christoph Niedermeier, München (DE); Wolfgang Mauerer, Donaustauf (DE); Karen Wintersperger, München (DE)

(73) Assignee: Siemens Aktiengesellschaft, München (DE)

(21) Appl. No.: 18/861,481

(22) PCT Filed: Apr. 14, 2023
(86) PCT No.: PCT/EP2023/059767

§ 371 Date: Oct. 29, 2024

(30) Foreign Application Priority Data
Apr. 29, 2022 (DE) 10 2022 204 264.6
Aug. 5, 2022 (EP) 22189043.7

(51) Int. Cl. G06N 10/60; G06N 10/40; G06N 10/70

(52) U.S. Cl. CPC G06N 10/60; G06N 10/40; G06N 10/70

(57) ABSTRACT

Various embodiments of the teachings herein include a method for solving a quantum computer problem. An example includes: applying a configurable quantum circuit with an arrangement of qubits; accepting a quantum computer problem; determining a solution algorithm based on the received quantum computer problem; determining a configuration of the qubits using the solution algorithm and a susceptibility to error of the solution algorithm; wherein the configuration includes a number of qubits for error correction dependent on the susceptibility to error of the solution algorithm; configuring the configurable quantum circuit with the determined configuration; and using the configured quantum circuit to solve the quantum computer problem.

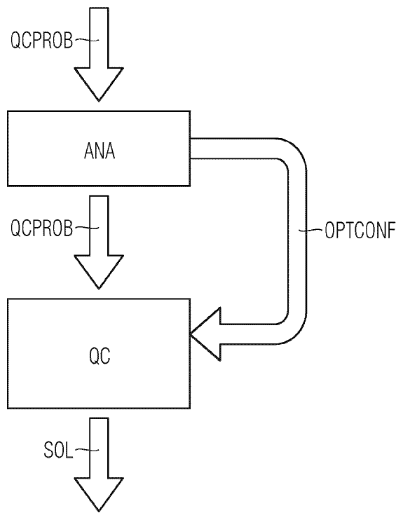

### CROSS-REFERENCE TO RELATED APPLICATIONS

This application is a U.S. National Stage Application of International Application No. PCT/EP2023/059767 filed Apr. 14, 2023, which designates the United States of America, and claims priority to EP Application No. 22189043.7 filed Aug. 5, 2022 and DE Application No. 10 2022 204 264.6 filed Apr. 29, 2022, the contents of which are hereby incorporated by reference in their entirety.

### TECHNICAL FIELD

The present disclosure relates to solving a quantum computer problem having a quantum circuit with an arrangement of qubits. Various embodiments of the teachings herein include methods and/or systems to solve a quantum computer problem.

### BACKGROUND

In electronic data processing there is a possibility of errors in the form of unwanted changes of bits. In classical computers, the causes of this are, for example, external influences such as cosmic radiation or radioactivity or solar flares, or noise effects during computational operations or during data transmission. However, in classical computers, classical bits are fault-tolerant, since the states “0” and “1” or “low” and “high” cover a sufficiently large voltage range and a small voltage deviation in the signal compared to this voltage range therefore has a minor effect on the read-out value of a classical bit.

In quantum computers, instead of performing computing operations on classical bits in a known manner, quantum computer operations are performed on qubits. Such quantum computer operations may include gate operations such as NOT or CNOT and, in their latest form, highly susceptible to errors since the energy levels for different quantum states of qubits barely differ from one another. External influences, such as caused by temperature as a result of an electrical signal, or internal influences, such as unwanted couplings between adjacent qubits or faulty quantum gates, can cause bit-flips or phase-flips, i.e. changes in phase shift, or combinations of these. For this reason, modern quantum computers must be strongly shielded and operated at low temperatures of a few millikelvin.

Successful continuation of the computation with faulty qubits in a quantum circuit is difficult if not impossible, depending on the degree of fault tolerance of the algorithm used. Classical error correction algorithms and error detection algorithms usually use redundancies in the data, such as parity bits or a multiplication of bits, so the majority of these multiplied bits can be assumed to indicate the intended value of the respective multiplied bits. However, such error correction algorithms and error detection algorithms are not possible when using quantum computers, because it is not possible to multiply states of qubits due to the no-cloning theorem.

Nevertheless, error correction is also possible with quantum computers. However, up to 1000 physical qubits are required for each logical qubit in order to be able to implement the logical qubit for actual applications. Even with particularly efficient quantum algorithms, error correction requires a number of additional qubits to be provided, which significantly exceeds the number of logical qubits. Current quantum computers have a very limited number of qubits. Consequently, current quantum computer problems cannot be adequately solved on this type of quantum computer, since only a few logical qubits are available on such quantum computers.

### SUMMARY

Teachings of the present disclosure include systems and/or methods for solving a quantum computer problem with a quantum circuit, and a quantum computer having a quantum circuit. For example, some embodiments include a method for solving a quantum computer problem, in which a configurable quantum circuit (QC) with an arrangement of qubits is applied and a quantum computer problem (QCPROB) is accepted, wherein a solution algorithm is determined according to the received quantum computer problem and a configuration of the qubits is determined according to the solution algorithm and a susceptibility to error of the solution algorithm, said configuration having a number of qubits for error correction dependent on the susceptibility to error of the solution algorithm, and wherein the configurable quantum circuit (QC) is configured with the determined configuration and the configured quantum circuit (QC) is used to solve the quantum computer problem (SOL).

In some embodiments, an error susceptibility of the solution algorithm is determined with respect to errors of individual steps of the solution algorithm and the configuration of the qubits is determined according to the error susceptibility of the solution algorithm with respect to the errors of the individual steps.

In some embodiments, the configuration has different numbers of physical qubits for different logical qubits for implementing the solution algorithm.

In some embodiments, such a configuration is determined which exhausts an available amount of qubits of the quantum circuit (QC).

In some embodiments, a measure of freedom from error of the solution is defined and such a configuration is determined that takes into account or satisfies the measure of the freedom from error of the solution.

In some embodiments, a measure of the complexity of the quantum computer problem is defined and the configuration is determined according to the complexity measure.

Some embodiments include a quantum computer having a configurable quantum circuit with an arrangement of qubits, wherein the quantum computer has an interface for accepting a quantum computer problem (QCPROB) and wherein the quantum computer (QC), in order to configure the quantum circuit, has a computing device which is designed to determine a solution algorithm depending on the accepted quantum computer problem (QCPROB), and to determine such a configuration of the configurable quantum circuit depending on the solution algorithm and on a susceptibility to error of the solution algorithm, which configuration has a number of qubits for error correction dependent on the susceptibility to error of the solution algorithm, wherein the quantum computer (QC) is designed to configure the quantum circuit according to the determined configuration.

In some embodiments, a quantum computer is designed to carry out one or more of the methods described herein.

In some embodiments, the quantum computer problem is a manufacturing problem and/or a maintenance problem and/or a logistics problem and/or a medical image recognition problem.

### BRIEF DESCRIPTION OF DRAWING

In the following the teachings are explained in more detail based on an exemplary embodiment shown in the drawing. The single drawing shows, schematically in a flow diagram, the sequence of a method incorporating teachings of the present disclosure for solving a quantum computer problem using a quantum computer incorporating teachings of the present disclosure having a configurable quantum circuit.

### DETAILED DESCRIPTION

The teachings of the present disclosure may be used for solving a quantum computer problem, a configurable quantum circuit with an arrangement of qubits is applied and a quantum computer problem is accepted, wherein a solution algorithm is determined according to the received quantum computer problem and a configuration of the qubits is determined according to the solution algorithm and a susceptibility to error of the solution algorithm, said configuration having a number of qubits for error correction dependent on the susceptibility to error of the solution algorithm. The configurable quantum circuit is configured with the determined configuration and the quantum computer problem is solved by means of the configured quantum circuit.

Such a configuration of the qubits may be determined depending on the solution algorithm and depending on the error susceptibility of the solution algorithm, which has a number of qubits for error correction dependent on the error susceptibility of the solution algorithm. By means of this dependency of the solution algorithm on the error susceptibility, the number of qubits required for error correction can be provided for the determined solution algorithm of the respective quantum computer problem. This number of qubits provided for error correction is therefore dependent on the solution algorithm and thus on the respective quantum computer problem.

Therefore, a number of qubits required for the error correction can be provided according to the quantum computer problem. As a result, it is only necessary to provide as many qubits for error correction as the error susceptibility of the solution algorithm requires. Therefore, there is no need to provide a predefined number of qubits that is independent of the specific quantum computer problem for the error correction. These embodiments allow the number of qubits required for error correction to be selected as small as necessary for the implementation of the solution algorithm. Consequently, the quantum circuit with a predefined number of qubits can be used to solve more complex quantum computer problems than previously known. Thus, a particularly large proportion of the qubits of the quantum circuit can be used as logical qubits, since they do not necessarily need to be available for error correction.

The error susceptibility of the solution algorithm may be determined with respect to errors of individual steps of the solution algorithm and the configuration of the qubits is determined according to the error susceptibility of the solution algorithm with respect to the errors of the individual steps. Thus, the number of qubits for error correction, which depends on the error susceptibility of the solution algorithm, can be specifically adjusted to the error susceptibility of the solution algorithm with respect to errors of individual steps of the solution algorithm. In some embodiments, the number of qubits for error correction is weighted differently for individual steps of the solution algorithm and matched to the error susceptibility of the solution algorithm with respect to errors of these individual steps. In particular, a different number of qubits for error correction is provided for specific individual steps of the solution algorithm than for other individual steps.

In some embodiments, the configuration has different numbers of physical qubits for different logical qubits for implementing the solution algorithm. In this refinement, physical qubits are provided for individual logical qubits in accordance with requirements, depending on the relevance of the errors occurring. For example, for some individual logical qubits error correction is crucial for solving the quantum computer problem and for other logical qubits, error correction is unnecessary. This state of affairs is taken into account in this refinement.

In some embodiments, such a configuration is determined which exhausts the available amount of qubits of the quantum circuit. In this way, the configuration can be selected in such a way that as many logical qubits as possible can be realized with the quantum circuit. Consequently, the quantum circuit can be configured in such a way that a maximally complex quantum computer problem can be solved with the quantum circuit.

In some embodiments, a measure of the freedom from error of a solution determined with the solution algorithm is defined and such a configuration determined which takes into account or satisfies the measure of the freedom from error of the solution. In this refinement, the measure for the freedom from error of the solution of the quantum computer problem can be used to determine the number of qubits for error correction. In particular in cases where only a low freedom from error is defined for a solution determined with the solution algorithm, the number of qubits for error correction can be estimated at a lower value than in cases where a higher freedom from error is specified.

In some embodiments, a measure of the complexity of the quantum computer problem is defined and the configuration is determined according to the complexity measure. In this refinement, a complexity of the quantum computer problem required for a real problem can be specified as a boundary condition and the number of qubits for error correction can be determined depending on this boundary condition. In this refinement, the amount of logical qubits for the implementation of the solution algorithm can therefore be specified and the freedom from error of a solution determined with the solution algorithm can be optimized, i.e. selected as high as possible.

In some embodiments, the quantum computer has a configurable quantum circuit with an arrangement of qubits, wherein the quantum computer has an interface for accepting a quantum computer problem and wherein the quantum computer, in order to configure the configurable arrangement of qubits, has a, e.g. classical, computing device which is designed to determine a solution algorithm depending on the accepted quantum computer problem and to determine such a configuration of the configurable quantum circuit depending on the solution algorithm and a susceptibility to error of the solution algorithm, which configuration has a number of qubits for error correction dependent on the susceptibility to error of the solution algorithm, wherein the quantum computer is designed to configure the quantum circuit according to the determined configuration. In some embodiments, the quantum computer according to the invention is designed and configured to carry out a method according to the invention as described above.

In some embodiments, the quantum computer is designed in one part, i.e. as an integrated single component. In some embodiments, the quantum computer forms a multi-part system, which comprises at least the quantum circuit and the computing device, which form separate components that are communicatively connected to each other.

The quantum computer described herein allows the method according to the invention to be carried out. The same advantages arise for the quantum computer incorporating teachings of the present disclosure as already explained for the methods. The refinements of the method, as described above, may be implemented mutatis mutandis in the quantum computers described herein, i.e. the quantum computer is suitably designed and configured specifically for the respective refinements of the methods.

In some embodiments, the quantum computer problem is a manufacturing problem and/or a maintenance problem and/or a logistics problem and/or a medical image recognition problem. Especially in the application cases of digital manufacturing and maintenance and logistics, complex problems regularly arise which can be solved by means of quantum computers and methods for solving a quantum computer problem. Especially in these cases, the use of the method and/or of the quantum computer may be therefore particularly advantageous.

The flow diagram depicted in the figure shows the sequence of a method incorporating teachings of the present disclosure for solving a quantum computer problem QCPROB in the form of a digital manufacturing task on a quantum computer incorporating teachings of the present disclosure. The digital manufacturing task relates to efficient planning of a production process under specified boundary conditions. In some embodiments, the quantum computer problem QCPROB is a different problem, such as a maintenance problem or a logistics problem or a medical image recognition problem. For this quantum computer problem QCPROB, a number of quantum algorithms for execution on a quantum computer are known. The quantum computer problem QCPROB is transferred to the quantum computer incorporating teachings of the present disclosure using an interface of the quantum computer.

The quantum computer problem QCPROB is accepted by a classical analytical computer ANA of the quantum computer in a first step and a quantum algorithm with a minimum possible number of necessary logical qubits is selected for solving the quantum computer problem QCPROB. For this purpose, the analytical computer ANA has a suitably programmed classical computing device with a database of known quantum algorithms. The selected quantum algorithm is implemented and solved on the configurable quantum circuit QC of the quantum computer in the final steps of the method.

For this purpose, in the method a logical ideal configuration of qubits is first provided, which in the case of error-free qubits would solve the quantum computer problem QCPROB by the ideal configuration implementing the selected quantum algorithm. However, this logical ideal configuration of qubits underestimates the number of qubits actually required. This is because for a realistic implementation a large number of error correction qubits is required which usually significantly exceeds the number of qubits for the ideal configuration, for example by several orders of magnitude, depending on the actual realization of the qubits.

Using the analytical computer ANA, an optimization algorithm is now applied that calculates a proportion of error correction qubits needed for a required reliable solution of the quantum computer problem QCPROB. For this purpose, the ideal configuration of qubits is first used and a weighting of the qubits of the ideal configuration is implemented, i.e. it is determined for which qubits an error correction is crucial and for which qubits an error correction is unnecessary. Thus, a certain proportion of error correction qubits can be determined, which is actually required for a real implementation of the ideal configuration of qubits. Thus, the qubits intended for the ideal configuration and the error correction qubits can be provided in the appropriate ratio for the configuration of the quantum circuit QC. In particular, it is thus possible to determine how many qubits are available in the configurable quantum circuit QC overall and the complexity of the ideal configuration can therefore be appropriately selected according to the ratio of qubits for the ideal configuration and error correction qubits, so that the maximum number of qubits is available for the ideal configuration and a sufficiently large number of error correction qubits is provided.

In accordance with the previously implemented weighting, in the configurable quantum circuit QC the configuration comprising the ideal configuration as well as the determined proportion of error correction qubits is configured by means of a configuration step OPTCONF. To do this, the analytical computer ANA outputs the configuration via an output interface and transfers the configuration to the quantum circuit. The quantum computer is designed to configure the quantum circuit using the configuration transferred to the quantum circuit. The configured quantum circuit QC is then used to solve the quantum computer problem QCPROB in a solution step SOL.

In some embodiments, a plurality of ideal configurations for solutions of the quantum computer problem QCPROB are used, wherein each of the ideal configurations is a configuration for solving the quantum computer problem QCPROB under the assumption of error-free qubits. The plurality of ideal configurations differ in the complexity of the quantum computer problem QCPROB that each of the ideal configurations can solve. For each of the ideal configurations, the required error correction qubits are determined and the total number of qubits required to realize the ideal configuration and to realize the error correction qubits is determined, so that multiple configuration candidates are available for the configuration of the configurable quantum circuit QC. The configuration candidate that exploits the largest possible amount of qubits of the quantum circuit QC is then used, and the configurable quantum circuit QC is configured with this configuration candidate. In this exemplary embodiment, the quantum computer problem QCPROB is then solved with the quantum circuit QC configured in this way.

What is claimed is:

1. A method for solving a quantum computer problem, the method comprising:
applying a configurable quantum circuit with an arrangement of qubits;
accepting a quantum computer problem;
determining a solution algorithm based on the received quantum computer problem;
determining a configuration of the qubits using the solution algorithm and a susceptibility to error of the solution algorithm;
wherein the configuration includes a number of qubits for error correction dependent on the susceptibility to error of the solution algorithm;
configuring the configurable quantum circuit with the determined configuration; and
using the configured quantum circuit to solve the quantum computer problem.

2. The method as claimed in claim 1, further comprising determining an error susceptibility of the solution algorithm with respect to errors of individual steps of the solution algorithm; and
wherein the configuration of the qubits is determined according to the error susceptibility of the solution algorithm with respect to the errors of the individual steps.

3. The method as claimed in claim 1, wherein the configuration includes different numbers of physical qubits for different logical qubits for implementing the solution algorithm.

4. The method as claimed in claim 1, wherein such a configuration is determined which exhausts an available amount of qubits of the quantum circuit.

5. The method as claimed in claim 1, wherein a measure of freedom from error of the solution is defined and such a configuration is determined that takes into account or satisfies the measure of the freedom from error of the solution.

6. The method as claimed in claim 1, wherein a measure of the complexity of the quantum computer problem is defined and the configuration is determined according to the complexity measure.

7. A quantum computer comprising:
a configurable quantum circuit with an arrangement of qubits;
an interface for accepting a quantum computer problem; and
a computing device designed to determine a solution algorithm depending on the accepted quantum computer problem and determine such a configuration of the configurable quantum circuit depending on the solution algorithm and on a susceptibility to error of the solution algorithm;
wherein the configuration has a number of qubits for error correction dependent on the susceptibility to error of the solution algorithm;
wherein the quantum computer configures the quantum circuit according to the determined configuration.

8-9. (canceled)
